(19) United States
(12) Patent Application Publication
(10) Pub. No.: US 2026/0067474 A1
(43) Pub. Date: Mar. 5, 2026

(54) AREA SCALABILITY

(71) Applicant: Tencent America LLC, Palo Alto, CA (US)

(72) Inventor: Stephan WENGER, Palo Alto, CA (US)

(21) Appl. No.: 19/310,823

(22) Filed: Aug. 26, 2025

Related U.S. Application Data
(60) Provisional application No. 63/688,286, filed on Aug. 28, 2024.

(51) Int. Cl. H04N 19/30; H04N 19/132; H04N 19/167

(52) U.S. Cl. CPC H04N 19/30; H04N 19/132; H04N 19/167

(57) ABSTRACT

An example method of video decoding includes receiving a video bitstream that comprises a base layer and at least one enhancement layer. The method further includes reconstructing the base layer and an enhancement layer of the at least one enhancement layers, where the enhancement layer's coded picture comprises coded blocks related to an area of samples and coded S-blocks unrelated to the area of samples. The method also includes determining a decoding complexity indicator based on at least the number of samples of the area after reconstruction. Systems and storage mediums for storing/executing instructions for performing the method are also disclosed.

### RELATED APPLICATIONS

This application claims priority to U.S. Provisional Patent Application No. 63/688,286 entitled “Area Scalability,” filed Aug. 28, 2025, which is hereby incorporated by reference in its entirety.

### TECHNICAL FIELD

The disclosed embodiments relate generally to video coding, including but not limited to a scalability mode in which certain spatial areas of a sequence of reconstructed pictures may be subjected to an enhancement layer.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

Uncompressed digital video can include a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed video has significant bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GByte of storage space.

One purpose of video coding and decoding is the reduction of redundancy in the input video signal, through compression. Compression can reduce the aforementioned bandwidth or storage space requirements, in some cases by two orders of magnitude or more. Both lossless and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signal may be small enough to make the reconstructed signal useful for the intended application. In the case of video, lossy compression is widely employed. The amount of distortion tolerated depends on the application; for example, users of certain consumer streaming applications may tolerate higher distortion than users of television contribution applications. The compression ratio achievable can reflect that: higher allowable/tolerable distortion can yield higher compression ratios.

The present disclosure describes techniques in which a coded enhancement layer picture (that may cover the same scene as the base layer) is used to enhance the quality of the reconstructed base layer picture by, for example, spatial or SNR scalability. As an example, in order to manage the processing overhead, the coded enhancement layer picture may be restricted to include no less than a predetermined number of coded blocks identified as S-blocks (e.g., skip blocks), whose decoding complexity may be known to be low. A measure of the relationship of S-blocks to other coded blocks may be included in the bitstream.

Using enhancement layers with partial regions of enhancement allows for scalability of quality where devices with limited resources can forgo using some (or all) of the enhancement layers and devices with more resources can use all of the layers to achieve the best quality.

In accordance with some embodiments, a method of video decoding includes (i) obtaining a layered video bitstream (e.g., a coded video sequence) comprising a base layer and an enhancement layer; (ii) reconstructing the base layer and the enhancement layer, where the enhancement layer's coded picture comprises coded blocks related to an area of samples and coded S-blocks unrelated to the area of samples; and (iii) determining a decoding complexity indicator based on at least the number of samples of the area after reconstruction.

In accordance with some embodiments, a method of video encoding includes (i) receiving video data (e.g., a source video sequence) comprising a plurality of frames; (ii) for a current frame of the plurality of frames, generating a base layer and an enhancement layer, where the enhancement layer's coded picture comprises coded blocks related to an area of samples and coded S-blocks unrelated to the area of samples. In some embodiments, the method further includes signaling the base layer and the enhancement layer in a layered video bitstream.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4 illustrates example NAL unit and SEI headers in accordance with some embodiments.

FIGS. 5A and 5B illustrate example types of scalability in accordance with some embodiments.

FIGS. 6A-6C illustrate examples of reconstructed pictures with areas of enhancement in accordance with some embodiments.

FIG. 7A illustrates an example video decoding process in accordance with some embodiments.

FIG. 7B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes a set of methods for video compression that enable area-specific enhancement through a layered approach. A coded enhancement layer picture may be used to enhance the quality of a reconstructed base layer picture in a specific spatial area of interest. The present disclosure provides techniques for managing processing overhead by restricting the enhancement layer to include at least a predetermined number of coded skip blocks (S-blocks) with known low-decoding complexity, while allowing higher quality coding for targeted areas. This approach offers significant technical benefits including: reduced bandwidth requirements for transmitting high-quality video by selectively enhancing only portions that require it; improved computational efficiency through the use of S-blocks in non-critical areas; flexible quality allocation based on content importance; and the ability to adapt enhancement strategies to different device capabilities through complexity indicators that signal the processing requirements of using each enhancement layers.

The use of multiple enhancement layers provides additional advantages by allowing receiving devices to selectively decode only those enhancement layers that match their processing capabilities and available bandwidth, enabling graceful degradation across a range of device capabilities. Network elements can intelligently decide which enhancement layers to transmit based on network conditions and client capabilities, optimizing bandwidth usage while maintaining critical visual quality. Furthermore, different enhancement layers can be coded using different profiles and coding tools specifically optimized for their content type—for example, using screen content coding tools for text regions while using different tools optimized for natural video in other regions—resulting in superior compression efficiency and visual quality for heterogeneous content.

### Example Systems and Devices

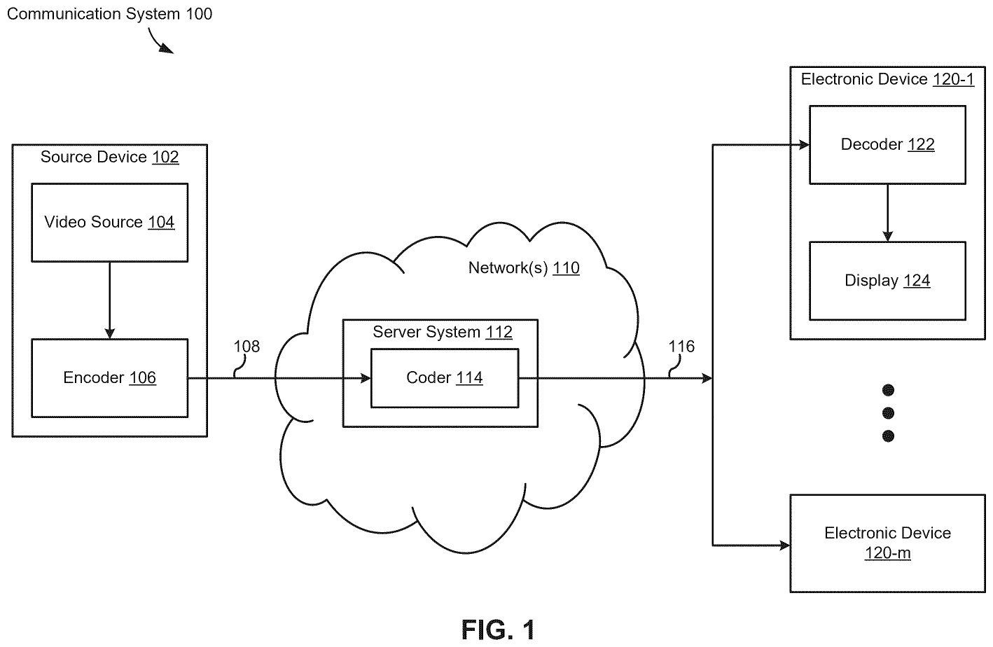

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including, e.g., wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116. In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

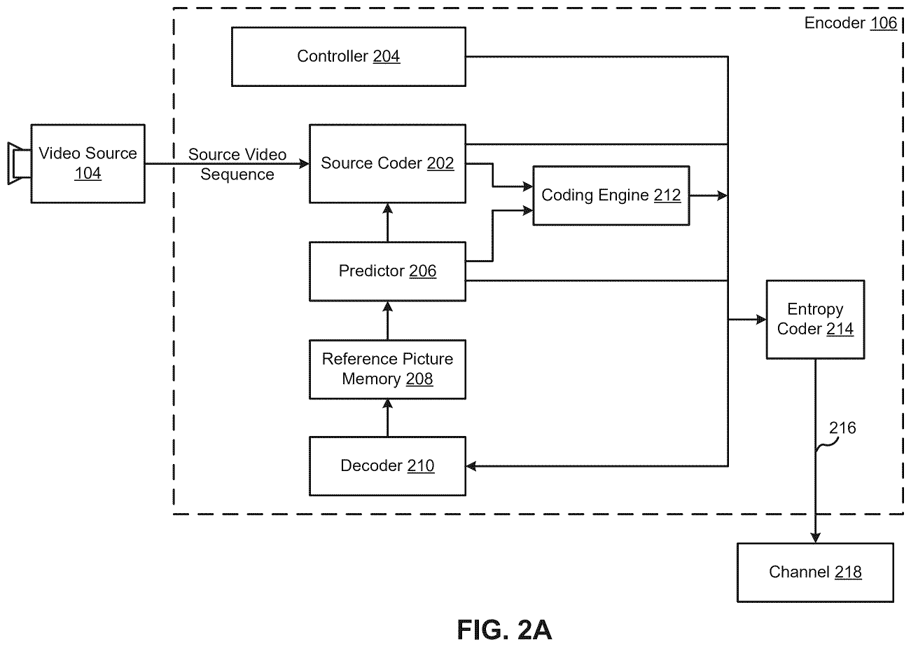

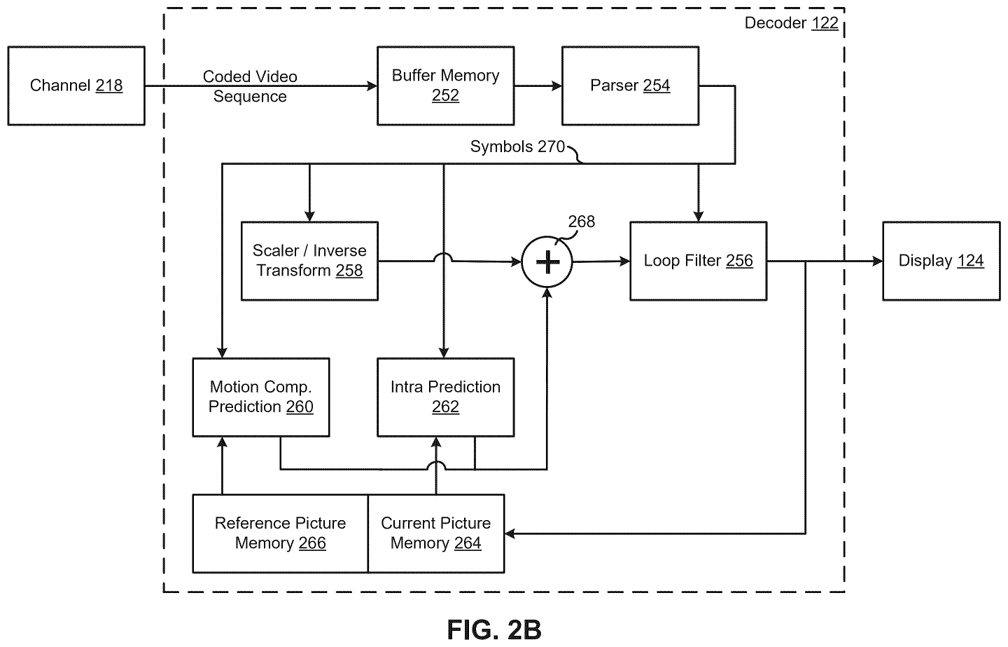

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, e.g., setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (e.g., blocks of 4×4, 8×8, 4×8, or 16×16 samples each) and coded on a block-by-block basis. Blocks may be coded predictively with reference to other (already coded) blocks as determined by the coding assignment applied to the blocks'respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, e.g., coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, e.g., information used to manage operation of the decoder component 122, and/or information to control a rendering device such as the display 124. The control information for the rendering device(s) may be in the form of, e.g., Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, e.g., X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (e.g., by parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. Levels may restrict the maximum picture size, maximum frame rate, maximum reconstruction sample rate (measured in, e.g., megasamples per second), maximum reference picture size, and so on. Limits set by levels may be further restricted through Hypothetical Reference Decoder (HRD) specifications and metadata for HRD buffer management signaled in the coded video sequence.

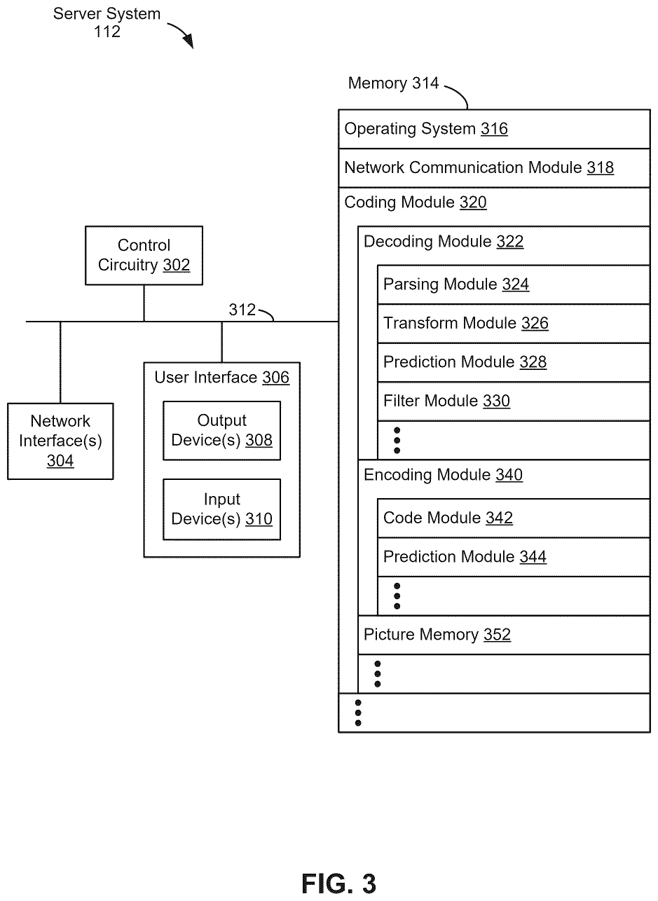

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). Compressed video can be augmented, in the video bitstream, by supplementary enhancement information, for example in the form of Supplementary Enhancement Information (SEI) Messages or Video Usability Information (VUI). Video coding standards can include specifications parts for SEI and VUI. SEI and VUI information may also be specified in stand-alone specifications that may be referenced by the video coding specifications.

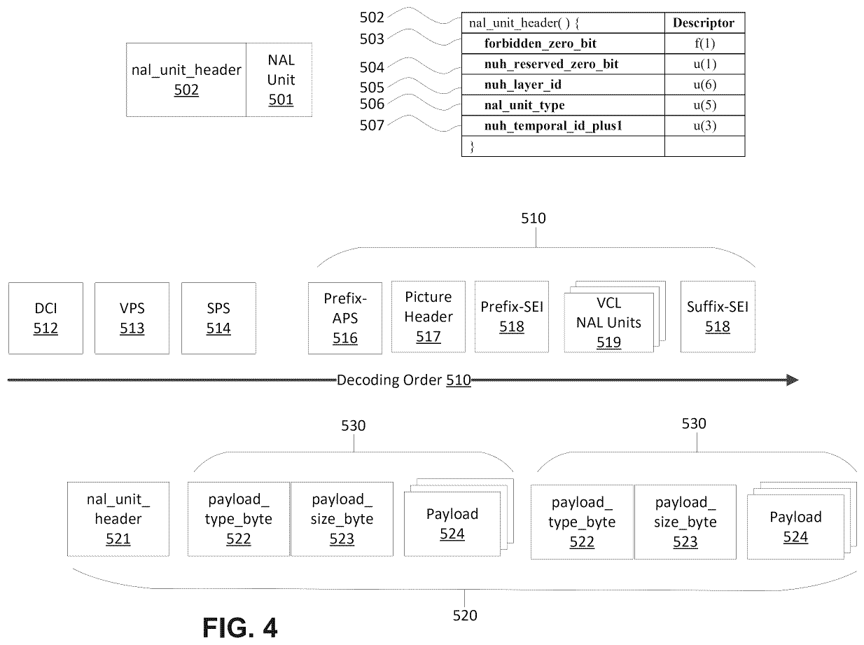

FIG. 4 shows an example layout of a Coded Video Sequence (CVS) in accordance with some video codecs. The example CVS is subdivided into Network Abstraction Layer units (NAL units). An example NAL unit (501) can include a NAL unit header (502), which in turn comprises multiple bits, e.g., 16 bits as follows: a forbidden_zero_bit (503) and nuh_reserved_zero_bit 504) may be unused by the codec and may be zero in a NAL unit. Three bits of nuh_layer_id (505) may be indicative of the (spatial, SNR, or multiview enhancement) layer to which the NAL unit belongs. Five bits of nuh_nal_unit_type (506) define the type of NAL unit. In an example codec, 22 NAL unit type values are defined for NAL unit types, six NAL unit types are reserved, and four NAL unit type values are unspecified and can be used by other specifications. Finally, three bits of the NAL unit header indicate the temporal layer to which the NAL unit belongs, nuh_temporal_id_plus1 (507).

A coded picture may contain one or more Video Coding Layer (VCL) NAL units and zero or more non-VCL NAL units. VCL NAL units may contain coded data conceptually belonging to a video coding layer. Non-VCL NAL units may contain data not conceptually belonging to the video coding layer. Using H.266 as an example, they can be categorized into
(1) Parameter sets, which comprise information that can be necessary for the decoding process and can apply to more than one coded picture. Parameter sets and conceptually similar NAL units may be of NAL unit types such as DCI_NUT (Decoding Capability Information (DCI)), VPS_NUT (Video Parameter Set (VPS), establishing, among other things, layer relationships), SPS_NUT (Sequence Parameter Set (SPS), establishing, among other things, parameters used and staying constant throughout a coded video sequence CVS), PPS_NUT (Picture Parameter Set (PPS), establishing, among other things, parameter used and staying constant within a coded picture), and PREFIX_APS_NUT and SUFFIX_APS_NUT (prefix and suffix Adaptation Parameter Sets). Parameter sets may include information required for a decoder to decode VCL NAL units, and hence are referred here as “normative” NAL units.
(2) Picture Header (PH_NUT), which is also a “normative” NAL unit.
(3) NAL units marking certain places in a NAL unit stream. Those include NAL units with the NAL unit types AUD_NUT (Access Unit Delimiter), EOS_NUT (End of Sequence) and EOB_NUT (End of Bitstream). These are non-normative, also known as informative, in the sense that a compliant decoder does not require them for its decoding process, although it needs to be able to receive them in the NAL unit stream.
(4) Prefix and Suffix SEI Nal unit types (PREFIX_SEI_NUT and SUFFIX_SEI_NUT) which indicate NAL units containing Prefix and Suffix supplementary enhancement information. In H.266 (04/2022), those NAL units are informative, as they are not required for the decoding process.
(5) Filler Data NAL unit type, FD_NUT, indicates filler data. Filler data can be random and can be used to “waste” bits in a NAL unit stream or bitstream, which may be necessary for the transport over certain isochronous transport environments.
(6) Reserved and Unspecified NAL unit types.

Still referring to FIG. 4, shown is a layout of a NAL unit stream in decoding order (510) containing a coded picture (511) containing NAL units of some of the types previously introduced. Somewhere early in the NAL unit stream, DCI (512), VPS (513), and SPS (514) may, in combination, establish the parameters which the decoder can use to decode the coded pictures of a coded video sequence (CVS), including coded picture (511) of the NAL unit stream.

The coded picture (511) can contain, in the depicted order or any other order compliant with the video coding technology or standard in use: a Prefix APS (516), Picture header (PH, 517), prefix SEI (518), one or more VCL NAL units (519), and suffix SEI (520).

Prefix and suffix SEI NAL units (518 and 520) were motivated during the standards development as, for some SEI messages, the content of the message would be known before the coding of a given picture commences, whereas other content would only be known once the picture were coded. Allowing certain SEI messages to appear early or late in a coded picture's NAL unit stream through prefix and suffix SEIs reduces/avoids buffering. As one example, in an encoder the sampling time of a picture to be coded is known before the picture is coded, and hence the picture timing SEI message can be a prefix SEI message (516). On the other hand, a decoded picture hash SEI message, which contains a hash of the sample values of a decoded pictures and can be useful, for example, to debug encoder implementations, is a suffix SEI message (518) as an encoder cannot calculate a hash over reconstructed samples before a picture has been coded. The location of Prefix and Suffix SEI NAL units may not be restricted to their position in the NAL unit stream. The phrase “Prefix” and “Suffix” may imply to what coded pictures or NAL units the Prefix/Suffix SEI message may pertain to, and the details of this applicability may be specified, for example in the semantics description of a given SEI message.

Still referring to FIG. 4, shown is a simplified syntax diagram of a NAL unit that contains a prefix or suffix SEI message (520). This syntax can be a container format for multiple SEI messages that can be carried in one NAL unit. Details of the extension mechanism for both payload size and payload type numbering range (e.g., specified in H.266) are omitted here for clarity. As other NAL units, SEI NAL units start with a NAL unit header (521). The header is followed by one or more SEI messages; two are depicted (530, 531) and described henceforth. Each SEI message inside the SEI NAL unit may include an 8 bit payload_type_byte (522) which specifies one of 256 different SEI types (or extension indication); an 8 bit payload_size_byte (523) which specifies the number of bytes of the SEI payload (or the presence of an extension block), and payload_size-byte number minus 1 bytes of Payload (524). The syntax of the Payload (524) depends on the SEI message, it can be of any length between 0 and 254 bytes unless the extension mechanism is used (not shown), in which case the syntax would allow for unlimited payload sizes.

Scalability, as disclosed herein, can be based on the concept of a coded video sequence (CVS) that may comprise more than one coded layer video sequence (CLVS), which is informally known as a layer. A compliant CVS may comprise at least one CLVS, which is informally known as the base layer. One or more additional CLVSs may also be included in the CVS, and those, depending on the profile used, may be informally called layers (in case of layered coding) or views (in case of multi-view coding). Temporally, a CVS is divided into Access Units (AUS). Each AU comprises one or more coded pictures, each belonging to a layer. When and how those potentially multiple coded pictures in an AU are decoded and how they are combined can be specified by the video coding standard or specification.

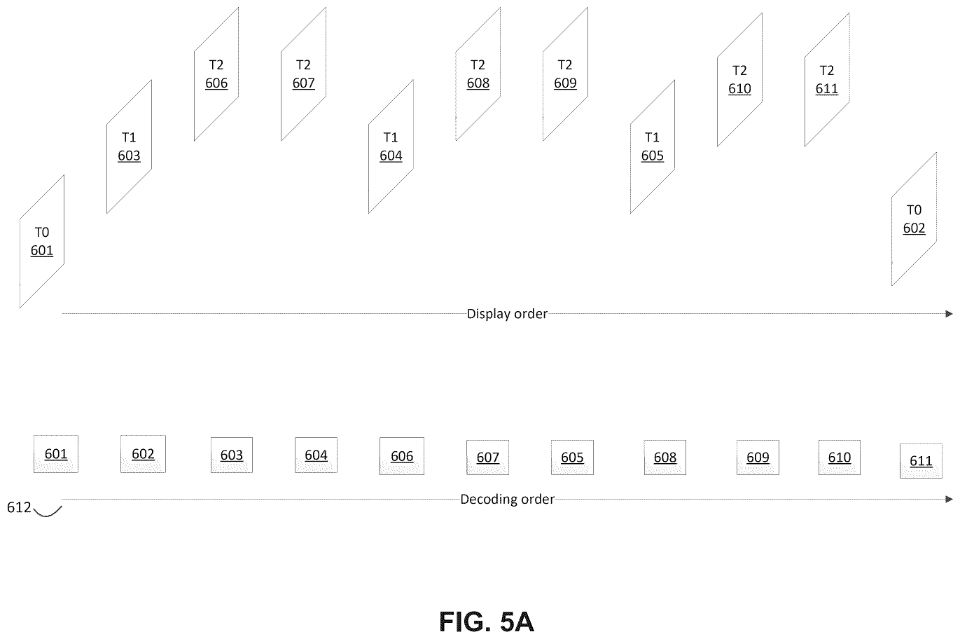

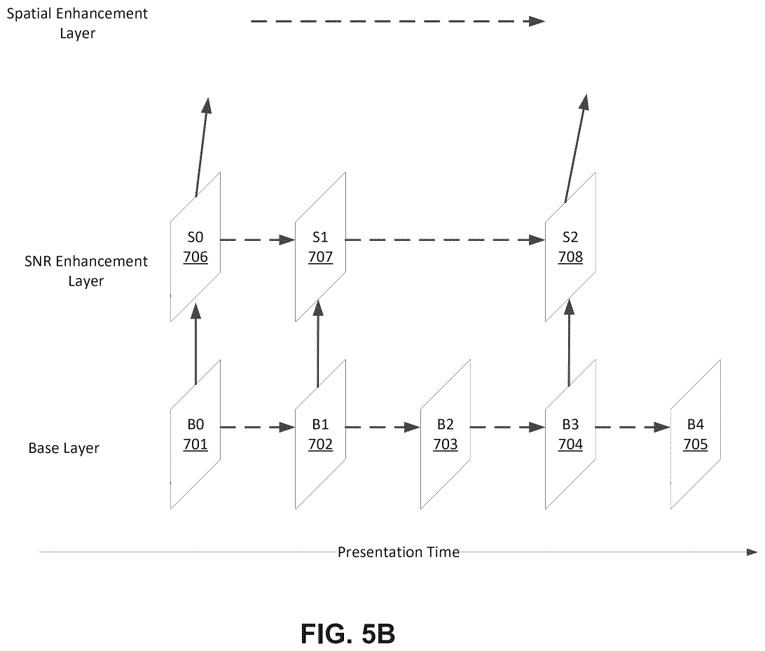

Referring to FIG. 5A, shown are three forms of scalability that some legacy and novel video codecs may employ. Whether a certain scalability type is supported by encoder or decoder depends on the video coding standard or technology, it's implementation, and may also depend on the profile or similar mechanisms that may be able to reduce the full functionality of a specification.

A first scalability type is known as temporal scalability (601). Temporal scalability is the one scalability type disclosed here that may operate on a single coded picture in an AU and, accordingly, within a CVS. When temporal scalability is employed, certain coded pictures are coded such that they are not required to reconstruct certain other pictures. Accordingly, those pictures may be removed from the CVS, or the decoder may choose not to decode them, with no negative impact on reproduced video quality but the reduction in frame rate.

For historic reasons, many existing video codec standards or specifications refer to those coded pictures associated with a temporal layer as a sublayer, and that convention is used herein as well.

Temporal scalability may have a (temporal) base layer, that may be defined as a set of coded pictures that have dependencies only to other base layer pictures. For example, the base layer pictures (601) and (602) depend only on each other, and not on any other depicted picture of enhancement layers. A temporal base layer is denoted herein by pictures labelled as T0. Shown in FIG. 5A are also sublayers T1 and T2. Pictures (603, 604, and 605) make up sublayer 1, and the remaining pictures (606 through 611) make up sublayer 2. Each sublayer picture can refer to pictures within its own sublayer, or to lower sublayer pictures (including the base layer) for prediction. Example prediction relationships are shown by arrows. A video codec standard or technology may disallow, or allow for, or require, signaling of prediction relationships that cross the nested nature of the prediction structure shown in FIG. 5A. For example, picture (610) is not predicted from picture (609), despite picture (609) being in the same sublayer; nor is picture (610) predicted from picture (604) of the sublayer 1. This restriction to a fully-nested prediction structure, in many cases, simplifies the description of scalability features and is henceforth assumed unless stated otherwise. However, such simplification and omittance of possible distracting complexity is not meant to limit the scope of the disclosed subject matter to fully nested CVSs or CLVSs; the techniques disclosed herein can equally be employed on not fully-nested scenarios.

Still referring to FIG. 5A, pictures are shown in the order of presentation sequence which, assuming a fixed capture frame rate, may be equivalent to presentation time. An example bitstream order that minimizes buffering memory as well as delay is shown (612) below the prediction structure. A decoder may have to have all pictures required for prediction available and reconstructed before attempting the reconstruction of a given picture—otherwise, information required for prediction may not be available. In some video coding standards and technology, this requirement dictates the order of coded pictures in a CVS (and CLVS), which may be expressed as a bitstream structure constraint. Certain system specifications mandate one or more defined prediction structures, and certain video codec specifications include metadata-based mechanisms that announce the prediction structure the encoder is using. Either or both can be employed to facilitate the detection of coded pictures that are required for reconstruction, for example through packet loss. An error resilient decoder can react to such information, for example, by omitting the decoding of the remainder of the pictures of the affected sublayer and all higher sublayers.

Referring to FIG. 5B, shown is an example of a prediction structure using temporal, spatial, and SNR layers. Shown are five access units (AUs), associated with the base layer coded pictures B0 (701) through B4 (705). The first access unit also includes an SNR enhancement layer picture S0 (706) that is inter-layer predicted from B0 (701), and a spatial enhancement layer picture E0 (709) that is predicted from the SNR enhancement layer picture S0 (706). Coded picture B0 (701), S0 (706), and E0 (709) share the same presentation time and are in the same access unit. Inter-layer prediction is shown by straight arrows. Temporal prediction is shown by dashed arrows. For example, picture B1 is temporally predicted from B0 (701) and B2 (703) is temporally predicted from B1 (702).

An AU does not necessarily include coded pictures of all enhancement layers. For example, the second AU, with B1 (702) as the base layer picture does include S1 (707) but no corresponding spatial enhancement layer coded picture. The third and fifth AUs depicted include only base layer pictures B2 (703) and B4 (705), respectively. This illustrates a combination of temporal and SNR/spatial scalability that, in some implementations, is in built into the design. In those implementations, an enhancement-layer size picture corresponding to the presentation time of AUs corresponding to B1 (702) and B2 (703) can still be reconstructed, and it may be updated relative to E0 (709) from information derived from the reconstruction of B1 (702), S1 (707) and B2 (703).

In some implementations, inter-layer prediction can be temporal, and can bypass layers. For example, some implementations may reconstruct picture E1 (710) from information derived from the reconstructed base layer B2 (703).

Further, some video coding standards and technologies use bi-prediction. While many still associate bi-prediction with temporal layering techniques only—where one prediction source may be a past and another a future decoded picture in presentation order—the concept of bi-prediction also encompasses inter-layer prediction. Some implementations include bi-prediction, which allows for a reconstructed sample to refer to sample and metadata related to zero, one, or two reference blocks. In some implementations, such, e.g., two, reference blocks can be freely chosen among any previously reconstructed picture still present in the reference picture buffer, regardless to which layer it may belong to.

In some implementations, the coded picture or parts thereof, for example slices or NAL units, may include headers that allow a decoder or middlebox to identify to which layer a certain picture or its part, belongs. That information can be present in header structures such as slice header, NAL unit header, picture header, and similar. Using such information, a decoder or a middlebox can remove pictures or parts thereof from a bitstream, or omit their decoding, if the information available in that layer is not required, or if the decoder or network has insufficient capacity to decode or convey such a layer. The base layer may be required in full and may form the lowest fidelity of reconstructed video. Enhancement layers, when available for decoding and after decoding, may increase fidelity in terms of time resolution/frame rate, sample fidelity, or spatial resolution.

In some implementations, included in the bitstream or associated metadata may be a directory or table of content that describes the scalable bitstream, its layers, their inter-layer prediction dependencies and so forth. Examples for such tables include those included in the Video Parameter Set of SHVC and VVC, or the PACSI NAL unit of RFC 6190.

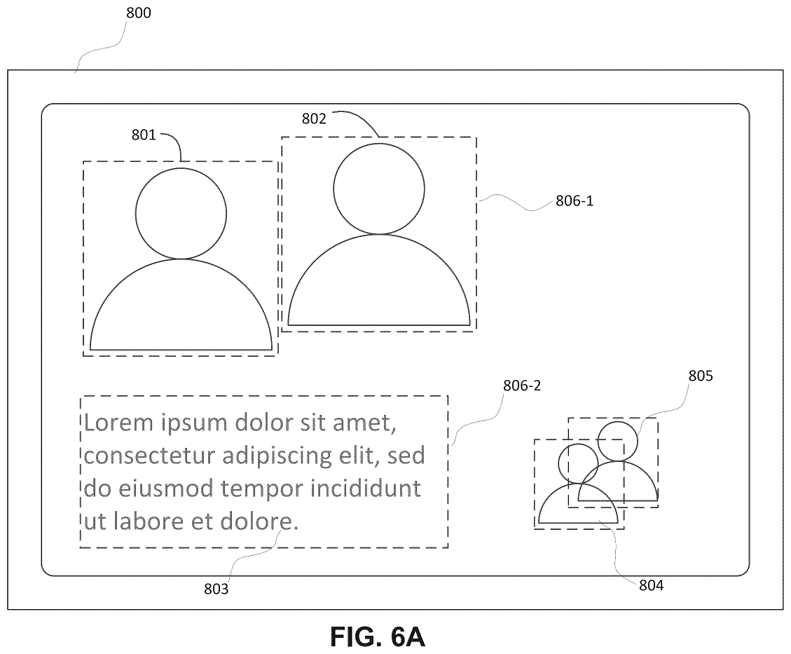

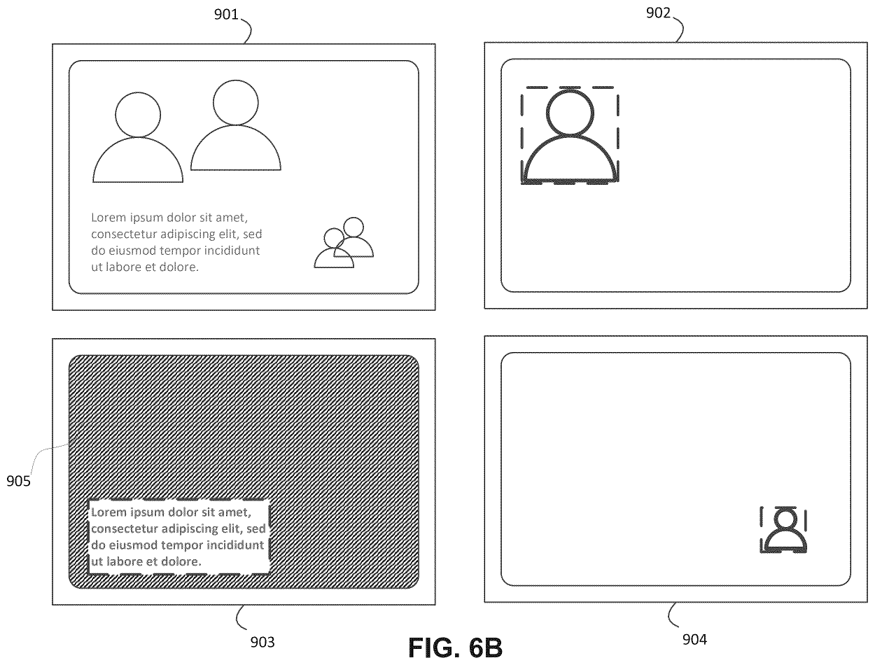

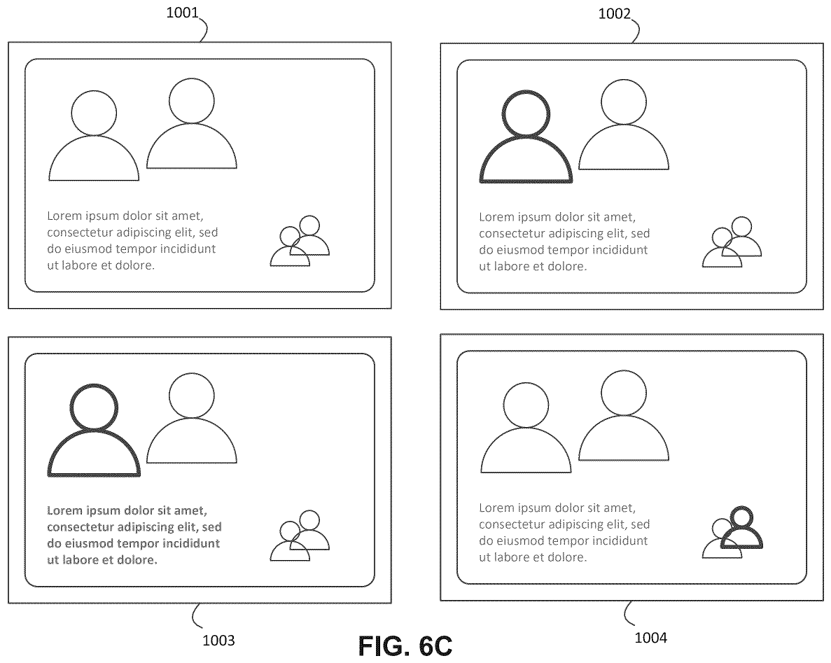

Referring to FIG. 6A, shown is an illustrative drawing of an example screen layout (800) of a reconstructed video, stemming from, for example, news content. Of non-background content, two subjects (801, 802) may be shown, along with an area dedicated to text (803) and two more persons (804, 805). Spatial areas (806) (e.g., rectangular areas) may be identified that cover the samples of the areas of interest. Those areas are depicted here as rectangles for implementation simplicity as well as for illustrative purposes. However, conceivably, the areas could be of any shape. Everything shown in the screen area (800) that's not covered specifically by an area, is considered background information henceforth. Areas can show natural camera content, for example persons (801), may be optimized to show text or graphics (803), and/or may overlap (804, 805).

In a bandwidth limited environment, and assuming the availability of scalability, the base layer may be coded at a fidelity that's insufficient for delightful user experience when it comes to the aforementioned areas (806), but adequate for the background. One or more enhancement layer(s) may be used to increase the fidelity of the areas (806). However, to represent content like the depicted, none of the scalability tools of current video coding standards or technologies is adequate. Specifically, all temporal, spatial, and SNR scalability code the whole picture, and not parts thereof.

Disclosed herein is an area scalability mechanism that fulfills the following requirements: (i) independent coding of a given area, that may be non-continuous or continuous, (ii) overlapping areas, (iii) areas using different tools. For example, the text (803) may be best represented using coding tools associated with screen content coding, whereas area (801) may be best represented using tools optimized for camera content. In some video coding standards or technologies, that may imply the need for support for different profile between areas.

Following additional requirements may also be fulfilled: (iv) manageable decoding complexity, not significantly exceeding the decoding complexity of a picture or layered picture the size of an area, and (v) as the placement of areas in a picture during the reconstruction process may be critical—the area is coded as an enhancement layer and may reference base samples of the background picture—placement information for the area may advantageously be coded in normative syntax rather than in metadata such as SEI messages.

Referring now to FIG. 6B, shown is the same scene as in FIG. 6A, now represented by a reconstructed base layer (901) and three area enhancement layers (902-904). Enhanced areas are represented by boldface font or heavy lines. The reconstructed base layer picture (901), accordingly, includes only light lines and non-bold font. The enhancement layer pictures (902-904) are shown as full size pictures, covering the same spatial area as the base layer picture (901). The areas of enhancement, within the dashed lines, can be coded using normal coding tools, such as inter (b-) block coding where, in some cases, advantageously one of the references may refer to the base layer. However, blocks outside the area (as indicated by the dashed lines) may be coded as “skip” blocks (S-blocks). An S-block may refer to a coded block of samples with only one reference, and that reference may be the reference layer without, or with only minimal application of, motion compensation, residual coding, loop filtering, or other techniques that manipulate sample values. In enhancement layer (903), samples represented by S-blocks (905) are shown as hatching. The effect of the use of an S-block in a given enhancement layer may be that the sample values of the reconstructed reference layer, in substantially unmodified form, may be the samples of the reconstructed given enhancement layer. In other words, when the blocks outside of the area indicated by dashed lines are coded as S-blocks, the background outside the area stays substantially unmodified.

Referring to FIG. 6C, shown are reconstructed base and enhancement layer pictures as indicated. Picture 1001 shows the base layer-all elements are visible, but none is enhanced as shown by regular font and standard weight lines. Picture 1002 represents base layer and enhancement layer 1. Picture 1003 represents the reconstructed and decode base, enhancement layer 1, and enhancement layer 2 pictures. Picture 1004 represents the reconstructed and decoded base and enhancement layer 3 picture.

Not depicted are certain other options for creating areas in enhancement layers. For example, non-continuous areas can be represented within a layer, by coding, using S-blocks, those areas outside the non-continuous area. As S-blocks may be small—in some video coding standards and technologies as small as 4×4 samples—a sufficient level of flexibility may be provided. Overlapping of areas may also be coded using S-blocks.

Having full-sized enhancement layer pictures instead of a hypothetical concept of an enhancement layer picture or sub-picture covering only parts of the base layer's sample area, for area enhancement has many advantages, including, for example, that SNR and possibly spatial enhancement layers as available in existing video coding standards and technologies may be used.

One issue with the technique as disclosed can be the potentially significant complexity increase of the decoding of the layered bitstream when using multiple enhancement layers. Consider FIG. 6C and assume the complexity of reconstructing the base layer (1001) may be 1. Reconstructing an enhancement layer should, in a reasonable software implementation, take considerably fewer cycles, assuming the reconstruction of an S-block takes very little effort—e.g., copying sample values and associated decoder metadata from a reference picture to a reconstructed picture. However, the understanding in many standards committees involving video coding is such that complexity must be measured in a manner accommodating worst case scenarios, as that is what hardware implementations need to provision for. The worst-case scenario in this technique would be that an area to be enhanced by an enhancement layer may comprise substantially all samples of the enhancement layer, with few or no S-blocks present. The decoding process of an enhancement layer may be very similar to that of the base layer or reference layer. Insofar, each enhancement layer's decoding complexity, assuming worst case, can also be assumed to be 1. Thus, in this example, the combined decoding complexity of two enhancement layers and the base layer required to reconstruct reconstructed picture (1003) (which is reconstructed from the base and two enhancement layers), may be 3. That is despite the number of samples that need reconstruction being substantially less than three times the number of samples of the base layer.

Worst case decoding complexity may be managed by introducing certain constraints and signaling of the presence of such constraints.

In some embodiments, decoding complexity may be considered as proportional to the number of samples to be reconstructed from non-S-blocks, per layer. In such a scenario—applicable perhaps to certain software-based implementations—a base layer may be assigned a complexity of, for example, the number of luma samples in a base layer picture. An enhancement layer's complexity may, for example, be assigned a complexity measured in the number of luma samples of the area that's not covered by S-blocks. Briefly referring to FIG. 6B, assume the base layer (901) resolution is 1080p or 1920×1080 luma samples. In that example, the complexity of the base layer may be 2,073,600. In contrast, the area of text enhanced by enhancement layer (903) may be 1000×300 samples, and all other samples are represented by S-blocks (905). In this example, the complexity associated with the enhancement layer (903) may be 300,000 or approximately 14.5% of that of the base layer. Similar numbers could be calculated for all desired enhancement layers, and adding those numbers could result in a number representing the decoding complexity of the desired layered bitstream.

Associating decoding complexity with sample count alone is, in at least some cases, inadequate because there may be (i) a certain overhead in processing the S-blocks, and (ii) a certain constant overhead. To reflect that, in some embodiments, the complexity of a layer is estimated by assigning a complexity factor to the decoding of S-blocks relative to the complexity of non-S-blocks. The above simplified formula assumes the decoding complexity of an S-block to be zero. If a non-zero value is to be assumed, the overall complexity can be calculated, for example, by calculating the complexity per sample of an enhancement layer as 1 (similar to above), whereas the decoding complexity of a sample associated with an S-block may be, for example, 0.1. In that case, the overall layer complexity for layer (903) may be 300000+0.1×(1920×1080/10)==507,360.

In some embodiments, further refinements are used. A non-exhaustive list of example factors includes: (i) a penalty based on the number of scan lines with non S-block content (to compensate for line buffer access); (ii) a penalty for the base layer decoding complexity based on bitrate, realizing that enhancement layer coded blocks may be considerably small on average than base layer coded block and hence may consume less cycles in the entropy decoding; and (iii) a penalty—possibly a constant—associated with each layer so to account for constant overhead in initiating layer decoding.

Once a decoding complexity per layer is calculated, that complexity can be considered by both encoder and decoder so to create a system that operates with less than the wors-case decoder complexity increase as described previously.

One mechanism to express decoding complexity in some implementations is known as a “level”. A level is, in some cases, a CVS or CLVS-wide number that may identify an upper limit of sample operations per seconds. In some implementations, levels can be associated with enhancement layers. For a given enhancement layer, a level may be assigned that is lower than what would be required to decode all samples of the layer at full frame rate. In those implementations, the underlying assumption can be that, if a lower level than required is coded for a layer, the frame rate of that layer must be reduced to stay within the sample processing requirements. In other words, levels, in these implementations, always assume worst case decoding complexity. This constraint can be modified by assuming the decoding complexity per layer as expressed by the level can be achieved by one of, or a combination of, reduced frame rate or increased S-block rate. From a syntax definition viewpoint, this is a minimal change from some current technologies and may be preferred. However, it substantially alters the level definition for enhancement layers and hence may not be agreeable for some codecs/standards as it may introduce a non-backward-compatible change.

In some embodiments, the level definition may remain the same, but another complexity indication is introduced in an appropriate high level syntax (HLS) structure or in metadata, that is indicative of decoding complexity with the assumption that S-blocks are less complex to decode than other blocks. Putting such information into a normative high-level syntax structure such as a parameter set—for example the H.265 or H.266 Video Parameter Set—can have the advantage that capability exchange and negotiation in a system—which is sometimes parameter-set based—can remain similar.

Another option can be to represent decoding requirements lower than worst case in non-normative metadata such as SEI messages. For example, an SEI may include a layer-id value indicative of the layer it applies to, and a number indicative of the decoding complexity of that layer according to one or more of the above calculations, or similar calculations. An encoder could include such an SEI message with a persistence scope as currently known, or, in some embodiments, with a persistence scope encompassing N future pictures of the enhancement layer. In this way, a decoder can receive an un-cancellable promise of maximum decoding complexity for a layer and can act accordingly. While not as advantageous as placing such a promise into a parameter set or other normative high level syntax structure, such an indication may be less disruptive and better than worst case assumptions.

In some embodiments, layers with a defined or guaranteed decoding complexity lower than worst case (as, for example, expressed as calculated above) are coded as a layer type different from SNR or enhancement layers.

Above discussion refers frequently to an S-block, which was previously identified as having two different features: first, its function can be as limited as copying reference picture samples to the current decoding picture, and second, its decoding complexity is low.

In early video coding technologies, for example in H.263 with Annex S enabled and no other optional modes enabled, the macroblock type “skip” can serve as an indication of an S-block. However, due to the complexity for more modern video coding standards, S-blocks may not be available directly in the syntax. Instead, it may be necessary to code an area in a way that interrupts certain in-picture prediction mechanisms to allow for bit-exact operations. Certain video coding standards and technologies include mechanisms that enable such disruption, for example: independent slices, isolated regions, or sub-pictures. When implementing the disclosed subject matter in a standards-compliant way, such mechanisms may advantageously be employed. If the disclosed subject matter is to be used in conjunction with newly devised video coding technology, it may be advantageous to define a block type specifically for the purpose referred to above.

With regards to overlapping areas, briefly referring to FIG. 6C, if in the lower right part of decoding 1004, both overlapping small person representations should be enhanced, and if the areas ought to be kept rectangular, then the question arises which enhancement layer is decoded first. In some embodiments, a traditional layered coding approach is used in which layers form a hierarchy. As such, information related to certain sample regions, cannot be available in an enhancement layer without having corresponding information in the reference layer present, without violating bitstream compliance. In some implementations, relying on this restriction can mean that a certain enhancement layer cannot be present without other enhancement layers also present in the AU, resulting in the limited choices by the encoder on what overlapping areas can be coded. This, however, is a limitation that advantageously should be avoided when devising a new video coding standard or technology.

In some embodiments, overlapping areas are implemented by using a layer type with similarities similar to multi-view coding. In multi-view coding, the layering syntax is used to describe multiple independent views rather than a hierarchy of layers. A bitstream can be a set of entities syntactically appearing similar to layers that do not form a hierarchy, and whose decoding can be independent from each other. In such a scenario, and when allowing overlaps, there may be a need to establish which layer's or view's information takes precedence over another. In other words, which layer is more to the foreground than the other. Such information can be established, for example, in metadata such as SEI messages, through a depth map, or through normative information creating a hierarchy of background to foreground in a high level syntax structure such as a video parameter set.

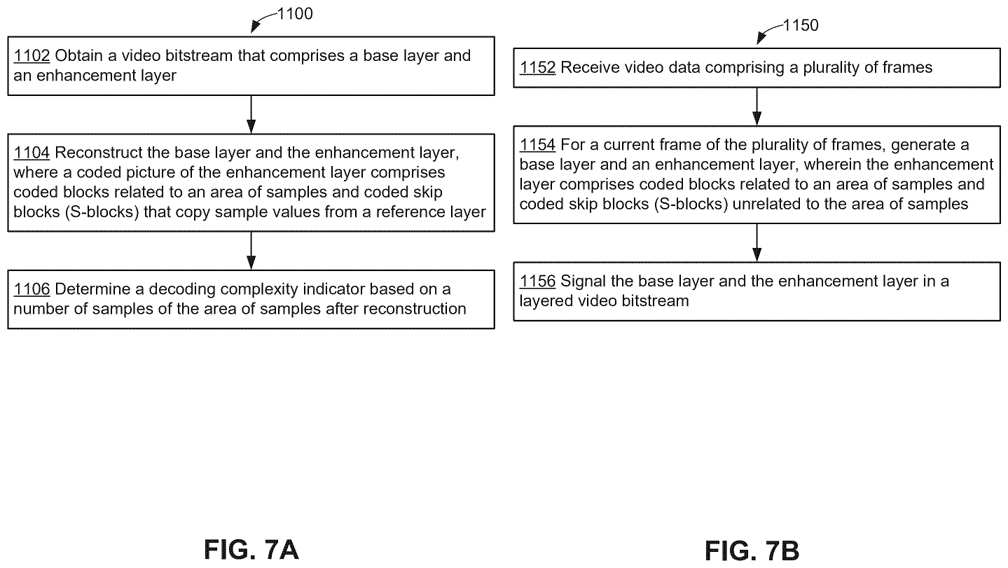

FIG. 7A is a flow diagram illustrating a method 1100 of decoding video in accordance with some embodiments. The method 1100 may be performed at a computing system (e.g., the server system 112, the source device 102, or the electronic device 120) having control circuitry and memory storing instructions for execution by the control circuitry. In some embodiments, the method 1100 is performed by executing instructions stored in the memory (e.g., the memory 314) of the computing system.

The system obtains (1102) a video bitstream that comprises a base layer and an enhancement layer. For example, the system may receive the video bitstream from a network connection, read it from a storage device, or receive it from a streaming server. The video bitstream may be formatted according to various video coding standards such as H.265/HEVC, H.266/VVC, or AV1. In some implementations, the video bitstream may include multiple enhancement layers, each corresponding to different areas of interest within the base layer. The base layer may provide a complete representation of the video content at a lower quality, while the enhancement layer provides improved quality for one or more specific spatial regions.

The system reconstructs (1104) the base layer and the enhancement layer, where a coded picture of the enhancement layer comprises coded blocks related to an area of samples and coded skip blocks (S-blocks) that copy sample values from a reference layer. The reconstruction process may involve entropy decoding, inverse quantization, inverse transform, motion compensation, and loop filtering operations. For the enhancement layer, the system may identify which blocks correspond to the area of interest requiring enhancement (e.g., a person's face, text overlay, or other visually important region) and which blocks are S-blocks. The S-blocks may be processed with minimal computational effort by simply copying corresponding sample values from the reference layer (e.g., the base layer). In some implementations, the system may use different decoding tools for different enhancement layers—for example, using screen content coding tools for text regions while using tools optimized for natural video in other regions.

The system determines (1106) a decoding complexity indicator based on a number of samples of the area of samples after reconstruction. This complexity indicator may be calculated in various ways, such as: (1) based on a ratio of coded blocks to S-blocks in the enhancement layer; (2) by counting the total number of samples in the enhanced area; (3) by applying a weighted formula that assigns different complexity factors to S-blocks versus regular coded blocks; and/or (4) by considering the number of scan lines containing non-S-block content. The complexity indicator may be used by the system to make decisions about whether to decode additional enhancement layers based on available processing resources. For example, a mobile device with limited processing capabilities might choose to decode only enhancement layers with complexity indicators below a certain threshold, while a high-performance device might decode all available enhancement layers. The complexity indicator may also be used for resource allocation, power management, or to provide feedback to the encoding system.

FIG. 7B is a flow diagram illustrating a method 1150 of encoding video in accordance with some embodiments. The method 1150 may be performed at a computing system (e.g., the server system 112, the source device 102, or the electronic device 120) having control circuitry and memory storing instructions for execution by the control circuitry. In some embodiments, the method 1150 is performed by executing instructions stored in the memory (e.g., the memory 314) of the computing system. In some embodiments, the method 1150 is performed by a same system as the method 1100 described above.

The system receives (1152) video data comprising a plurality of frames. The video data may be received from various sources, such as a digital camera capturing live content, a pre-recorded video file stored in memory, or a video stream transmitted over a network connection. The video data may be in various formats, such as uncompressed YCbCr 4:2:0 format, RGB format, or any other suitable color space and sampling structure. The frames may have various resolutions (e.g., 1920×1080, 3840×2160, or other dimensions) and may be received at different frame rates (e.g., 24, 30, 60, or 120 frames per second).

For a current frame of the plurality of frames, the system generates (1154) a base layer and an enhancement layer, wherein the enhancement layer comprises coded blocks related to an area of samples and coded skip blocks (S-blocks) unrelated to the area of samples. The base layer may be encoded at a lower quality or resolution to provide a complete representation of the frame that can be decoded by all devices. The enhancement layer may be generated to improve specific areas of interest within the frame, such as faces, text regions, or other visually important content. The system may identify these areas of interest automatically using content analysis algorithms (e.g., face detection, text detection, or motion analysis), or the areas may be manually specified. The coded blocks within the area of interest may use various coding tools optimized for the specific content type—for example, screen content coding tools for text regions or tools optimized for natural video in other regions. Outside these areas of interest, the system encodes S-blocks that simply reference the corresponding areas in the base layer, requiring minimal processing during decoding. In some implementations, the system may generate multiple enhancement layers for different areas of interest, potentially using different coding profiles or tools for each enhancement layer based on the content characteristics.

The system signals (1156) the base layer and the enhancement layer in a layered video bitstream. This signaling may include embedding information in the bitstream to indicate the layer structure, the spatial regions covered by each enhancement layer, and the decoding complexity indicators for each layer. The signaling may be implemented through various mechanisms, such as Network Abstraction Layer (NAL) unit headers that identify layer membership, parameter sets (e.g., Video Parameter Sets, Sequence Parameter Sets) that describe layer relationships, or Supplementary Enhancement Information (SEI) messages that provide additional metadata about the enhancement layers. The system may also signal guaranteed percentages of S-blocks for each enhancement layer to help decoders estimate processing requirements. Additionally, the system may include information about layer dependencies, allowing decoders to selectively process only those enhancement layers that match their capabilities or current network conditions. The layered video bitstream may be formatted according to various video coding standards such as H.265/HEVC, H.266/VVC, or AV1, with appropriate extensions to support the area-specific enhancement layer functionality.

Although FIGS. 7A and 7B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.
(A1) In one aspect, some embodiments include a method (e.g., the method 1100) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a base layer and an enhancement layer; (ii) reconstructing the base layer and the enhancement layer, wherein a coded picture of the enhancement layer comprises coded blocks related to an area of samples and coded skip blocks (S-blocks) that predict sample values by copying from a reference layer; and (iii) determining a decoding complexity indicator based on a number of samples of the area of samples after reconstruction. In some embodiments, the S-blocks copy the values from the reference layer directly. In some embodiments, the S-blocks copy the values and then perform some (e.g., minimal) filtering and/or other types of manipulation.
(A2) In some embodiments of A1, the decoding complexity indicator is based on a ratio of the coded blocks related to the area of samples to the coded S-blocks. For example, if an enhancement layer contains 1000 total blocks with 300 coded blocks for the area of interest and 700 S-blocks, the ratio would be 3:7 or approximately 0.43. This ratio can be used to estimate processing requirements, with lower ratios indicating lower computational complexity. In some embodiments, the ratio is weighted, e.g., with coded blocks assigned a weight of 1.0 and S-blocks assigned a lower weight (e.g., 0.1) to reflect their reduced processing requirements. The ratio may also be calculated on a per-scanline basis to account for memory access patterns that affect decoding efficiency.
(A3) In some embodiments of A1 or A2, the video bitstream comprises an indicator indicating a guaranteed percentage of S-blocks for the enhancement layer. This indicator may be signaled in a high-level syntax structure such as a Video Parameter Set (VPS), Sequence Parameter Set (SPS), or Picture Parameter Set (PPS). For example, the bitstream may include a field with values ranging from 0 to 100, indicating the minimum percentage of blocks in the enhancement layer that are guaranteed to be S-blocks. In some embodiments, this indicator is included in a Supplementary Enhancement Information (SEI) message, e.g., with a persistence scope covering multiple frames, allowing decoders to plan resource allocation across a sequence of pictures.
(A4) In some embodiments of A3, the method further comprises determining whether to reconstruct the enhancement layer based on the indicator. For example, a mobile device with limited processing capabilities may establish a threshold of 70% S-blocks, only decoding enhancement layers that meet or exceed this threshold. In another example, a decoder may dynamically adjust its decision based on current system load, battery status, or thermal conditions—choosing to decode enhancement layers with at least 50% S-blocks under normal conditions but increasing the threshold to 80% when battery is low, or the device is running hot. The decoder may also consider multiple factors simultaneously, such as the guaranteed S-block percentage, available memory bandwidth, and the importance of the enhanced area (e.g., prioritizing face regions in a video conference).
(A5) In some embodiments of any of A1-A4, the enhancement layer is coded using a different profile than the base layer. For instance, the base layer might use a main profile optimized for general video content, while the enhancement layer uses a different profile with specialized tools. This allows for tailoring the coding tools to the specific content characteristics of each layer. In one example, the base layer might use a main profile while an enhancement layer uses a profile with screen content coding tools enabled. Different profiles may also employ different bit rates, with the base layer using a lower bit rate for bandwidth efficiency while enhancement layers use higher bit rates for improved quality in areas of interest. Additionally, profiles may implement different filtering approaches, such as the base layer using standard deblocking filters while enhancement layers employ more sophisticated adaptive loop filters or sample adaptive offset filtering to better preserve details in critical regions. Profiles may also differ in their quantization parameters, transform block sizes, and motion vector precision, allowing each layer to be optimized for its specific purpose and content type.
(A6) In some embodiments of A5, the enhancement layer is coded using a profile for screen-shared content. For example, the enhancement layer may use H.266/VVC Screen Content Coding (SCC) extensions when enhancing regions containing text, graphics, or computer-generated imagery. This profile may enable specialized tools that are particularly effective for screen content. In a video conferencing scenario, an enhancement layer might use SCC tools to improve the quality of shared presentation slides or documents, while the base layer uses tools optimized for camera-captured content. The decoder may identify the profile through explicit signaling in the bitstream, such as in the SPS or VPS.
(A7) In some embodiments of any of A1-A6, the video bitstream comprises a plurality of enhancement layers, each enhancement layer corresponding to a different area of interest within the base layer. For instance, in a news broadcast, separate enhancement layers might be used for: (1) the news anchor's face, (2) a picture-in-picture sports highlight, (3) a scrolling text ticker, and (4) a weather map graphic. In some embodiments, each enhancement layer can be independently decoded based on available resources and/or viewer preferences. In a video conferencing application, enhancement layers might correspond to each participant's face region, allowing the system to prioritize quality for active speakers. The enhancement layers may be organized hierarchically or as independent layers, with their relationships and dependencies signaled in the bitstream.
(A8) In some embodiments of A7, the plurality of enhancement layers include a first enhancement layer and a second enhancement layer, and the first enhancement layer and the second enhancement layer are coded using different coding tools. For example, in a mixed-content video, a first enhancement layer covering a text region might use screen content coding tools like Intra Block Copy and Palette Mode, while a second enhancement layer covering a person's face might use tools optimized for natural video such as advanced motion compensation and film grain synthesis. In another implementation, one enhancement layer might use tools optimized for high spatial detail (e.g., stronger deblocking filters, directional intra prediction modes) while another uses tools for temporal consistency (e.g., weighted prediction, long-term reference pictures). The specific tools used for each enhancement layer may be signaled through syntax elements in the layer headers or parameter sets.
(A9) In some embodiments of any of A1-A8, the reference layer is the base layer. For example, all enhancement layers may directly reference the reconstructed samples from the base layer when decoding S-blocks, simplifying the dependency structure. In this configuration, each enhancement layer can be decoded independently of other enhancement layers, requiring only the base layer to be available. This allows for flexible decoding where any combination of enhancement layers can be applied to the base layer. In some implementations, the reference relationship may be explicitly signaled in the Video Parameter Set through a direct_dependency_flag matrix or similar syntax element, indicating that each enhancement layer depends only on the base layer.
(A10) In some embodiments of any of A1-A9, the area of samples corresponds to an area of interest in the base layer. For example, in a sports broadcast, the area of interest might be a player's face, the scoreboard, or the ball in play. In a video conference, areas of interest might include participants'faces or shared presentation content. These areas may be identified automatically through content analysis algorithms (e.g., face detection, text detection, motion analysis) or manually specified by content creators. The areas of interest may be static throughout a sequence or dynamically updated on a frame-by-frame basis. In some implementations, metadata about the areas of interest may be included in the bitstream through SEI messages, allowing decoders or downstream systems to utilize this information for other purposes such as viewport-adaptive streaming or attention visualization.
(B1) In another aspect, some embodiments include a method (e.g., the method 1150) of video encoding. In some embodiments, the method is performed at a computing system having memory and one or more processors. The method includes: (i) receiving video data (e.g., a source video sequence) comprising a plurality of frames; (ii) for a current frame of the plurality of frames, generating a base layer and an enhancement layer, wherein the enhancement layer comprises coded blocks related to an area of samples and coded skip blocks (S-blocks) unrelated to the area of samples; and (iii) including the base layer and the enhancement layer in a layered video bitstream.
(B2) In some embodiments of B1, the method further comprises determining a first indicator indicating a decoding complexity for the enhancement layer based on a number of samples of the area of samples. The first indicator may be calculated using various approaches, such as: (i) a simple count of the total number of samples in the enhanced area; (ii) a weighted formula that assigns different complexity factors to S-blocks versus regular coded blocks (e.g., assigning a weight of 1.0 to regular coded blocks and 0.1 to S-blocks); (iii) a calculation that considers the number of scan lines containing non-S-block content to account for memory access patterns; or (iv) a formula that incorporates bitrate information to reflect entropy decoding complexity. For example, in a 1920×1080 frame with an enhancement area of 500×300 pixels, the indicator might represent the 150,000 samples in the enhanced area, potentially with additional weighting factors. This indicator may be signaled in a high-level syntax structure such as a Video Parameter Set (VPS), Sequence Parameter Set (SPS), or through Supplementary Enhancement Information (SEI) messages with a defined persistence scope.
(B3) In some embodiments of B2, the method further comprises generating a second enhancement layer, where the second enhancement layer corresponds to a second area of samples, different than the area of samples in the enhancement layer. For example, in a video conferencing scenario, the first enhancement layer might enhance a primary speaker's face region, while the second enhancement layer enhances a shared presentation or document area. The second enhancement layer may be generated using different coding tools optimized for its specific content type—for instance, using screen content coding tools for text regions while the first enhancement layer uses tools optimized for natural video. The second enhancement layer may be coded at a different quality level, bit depth, or chroma sampling format than the first enhancement layer. In some implementations, the second enhancement layer may partially overlap with the first enhancement layer, with a defined precedence order determining which layer's samples take priority in the overlapping regions. The second enhancement layer may also be assigned a different temporal update frequency than the first enhancement layer, allowing more frequent updates to more dynamic content while using fewer updates for more static regions.
(B4) In some embodiments of B3, the method further comprises determining a second indicator indicating a decoding complexity for the second enhancement layer based on a number of samples of the second area of samples. The second indicator may be calculated using the same methodology as the first indicator or using a different approach tailored to the characteristics of the second enhancement layer. For example, if the second enhancement layer contains screen content that benefits from specialized coding tools like Intra Block Copy (IBC) or Palette Mode, the complexity calculation might include additional factors to account for the computational requirements of these tools. The second indicator might also incorporate a temporal factor if the second enhancement layer is updated at a different frequency than the first enhancement layer. In some implementations, the complexity calculation might consider the specific hardware acceleration capabilities available for different types of content-for instance, if dedicated hardware exists for processing screen content versus natural video content. The second indicator allows decoders to make informed decisions about whether to decode both enhancement layers or to prioritize one over the other based on available processing resources, power constraints, or quality requirements.
(B5) In some embodiments of B4, the method further comprises signaling the first indicator and the second indicator in the layered video bitstream. The indicators may be signaled through various mechanisms, such as: (i) dedicated syntax elements in parameter sets (e.g., VPS, SPS, or PPS); (ii) SEI messages with appropriate persistence scopes; (iii) as part of enhancement layer headers; or (iv) in a separate metadata track. The signaling may include not only the raw complexity indicators but also additional information such as guaranteed minimum percentages of S-blocks, maximum processing requirements expressed in operations per second, or recommended decoder capabilities. In some implementations, the indicators may be updated dynamically throughout a sequence to reflect changing content characteristics. For example, during a video conference, the complexity indicators might be updated when a new participant begins speaking or when shared content changes significantly. The signaling may also include relative priority information to help decoders determine which enhancement layer to process first or which to drop under constrained conditions. In adaptive streaming scenarios, the indicators may be used by network elements to make intelligent decisions about which enhancement layers to transmit based on available bandwidth and client capabilities.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., the methods 1100 and 1150, as well as A1-A10 and B1-B5 above). In another aspect, some embodiments include a non-transitory computer-readable storage medium storing one or more sets of instructions for execution by control circuitry of a computing system, the set(s) of instructions including instructions for performing any of the methods described herein (e.g., the methods 1100 and 1150, as well as A1-A10 and B1-B5 above). In some embodiments, a memory or non-transitory computer-readable storage medium stores a video bitstream including any of the features (e.g., syntax and encoded information) disclosed herein.

Unless otherwise specified, any of the syntax elements described herein may be HLS. As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
obtaining a video bitstream that comprises a base layer and an enhancement layer;
reconstructing the base layer and the enhancement layer, wherein a coded picture of the enhancement layer comprises coded blocks related to an area of samples and coded skip blocks (S-blocks) that predict sample values by copying from a reference layer; and
determining a decoding complexity indicator based on a number of samples of the area of samples after reconstruction.

2. The method of claim 1, wherein the decoding complexity indicator is based on a ratio of the coded blocks related to the area of samples to the coded S-blocks.

3. The method of claim 1, wherein the video bitstream comprises an indicator indicating a guaranteed percentage of S-blocks for the enhancement layer.

4. The method of claim 3, further comprising determining whether to reconstruct the enhancement layer based on the indicator.

5. The method of claim 1, wherein the enhancement layer is coded using a different profile than the base layer.

6. The method of claim 5, wherein the enhancement layer is coded using a profile for screen-shared content.

7. The method of claim 1, wherein the video bitstream comprises a plurality of enhancement layers, each enhancement layer corresponding to a different area of interest within the base layer.

8. The method of claim 7, wherein the plurality of enhancement layers include a first enhancement layer and a second enhancement layer, and wherein the first enhancement layer and the second enhancement layer are coded using different coding tools.

9. The method of claim 1, wherein the reference layer is the base layer.

10. The method of claim 1, wherein the area of samples corresponds to an area of interest in the base layer.

11. A method of video encoding performed at a computing system having memory and one or more processors, the method comprising:
receiving video data comprising a plurality of frames;
for a current frame of the plurality of frames, generating a base layer and an enhancement layer, wherein the enhancement layer comprises coded blocks related to an area of samples and coded skip blocks (S-blocks) unrelated to the area of samples; and
including the base layer and the enhancement layer in a layered video bitstream.

12. The method of claim 11, further comprising determining a first indicator indicating a decoding complexity for the enhancement layer based on a number of samples of the area of samples.

13. The method of claim 12, further comprising generating a second enhancement layer, wherein the second enhancement layer corresponds to a second area of samples, different than the area of samples in the enhancement layer.

14. The method of claim 13, further comprising determining a second indicator indicating a decoding complexity for the second enhancement layer based on a number of samples of the second area of samples.

15. The method of claim 14, further comprising signaling the first indicator and the second indicator in the layered video bitstream.

16. A non-transitory computer-readable storage medium storing a layered video bitstream that is generated by a video encoding method, the layered video bitstream comprising:
a base layer corresponding to multiple frames of video data; and
a first enhancement layer comprising coded blocks corresponding to a first area of interest in the base layer and coded skip blocks (S-blocks) for areas outside of the first area of interest.

17. The non-transitory computer-readable storage medium of claim 16, wherein the layered video bitstream further comprises an indicator indicating a number of samples of the first area of samples.

18. The non-transitory computer-readable storage medium of claim 16, wherein the layered video bitstream further comprises a second enhancement layer, wherein the second enhancement layer corresponds to a second area of samples, different than the first area of samples in the first enhancement layer.

19. The non-transitory computer-readable storage medium of claim 18, wherein the layered video bitstream further comprises a second indicator indicating a number of samples of the second area of samples.

20. The non-transitory computer-readable storage medium of claim 18, wherein the first enhancement layer is coded using a different set of tools than the second enhancement layer.
